(19) United States
(12) Patent Application Publication
(10) Pub. No.: US 2020/0065641 A1
(43) Pub. Date: Feb. 27, 2020

(54) METAL CHIP CARD BODY

(71) Applicant: Infineon Technologies AG, Neubiberg (DE)

(72) Inventors: Walther Pachler, Graz (AT); Siegfried Hoffner, Nesselwang (DE)

(21) Appl. No.: 16/110,590

(22) Filed: Aug. 23, 2018

(51) Int. Cl. G06K 19/077; G06K 19/02

(52) U.S. Cl. CPC G06K 19/07722; G06K 19/07773; G06K 19/02

(57) ABSTRACT

A chip card body, including a first metal layer having a first aperture, and an opening or recess configured to receive a coil-chip combination; a second metal layer having a second aperture; and a booster antenna inlay laminated between the first and second metal layers and configured to couple with the coil-chip combination.

### BACKGROUND

Credit cards have been used as a form of payment for over half a century. Initially, instead of swiping a plastic credit card in a merchant's card reader, cardboard cards were used to barter for products and services as a form of short-term credit. By the 1960 s, the cardboard cards were replaced with plastic cards.

Plastic credit cards often include security features. An over-laminated holographic is one of the most visual security features, difficult to forge, and easy to authenticate. The general trend is that the more unique features a card has, the more desirable.

Metal credit cards offer an allure not found with plastic cards, that is, the “plunk” factor. Throwing down a credit card with the heft and sheen that only metal provides is a status symbol. This trend is not only with credit cards, but also with identification cards, and especially highly-prized membership cards for a golf clubs, noble fitness centers, etc.

### BRIEF DESCRIPTION OF THE DRAWINGS

FIG. 1A illustrates a schematic diagram of a side view of a chip card body in accordance with aspects of the disclosure.

FIG. 1B illustrates a schematic diagram of a side view of a chip card body in accordance with aspects of the disclosure.

FIG. 2A illustrates a schematic diagram of a side view of a chip card in accordance with aspects of the disclosure.

FIG. 2B illustrates a schematic diagram of a side view of a chip card in accordance with aspects of the disclosure.

FIG. 2C illustrates a schematic diagram of a side view of a chip card in accordance with aspects of the disclosure.

FIG. 3A illustrates a schematic diagram of a side view of a chip card in accordance with aspects of the disclosure.

FIG. 3B illustrates a schematic diagram of a side view of a chip card in accordance with aspects of the disclosure.

FIG. 4 illustrates chip card component sheets in accordance with aspects of the disclosure.

FIG. 5 illustrates chip card components and a chip card in accordance with aspects of the disclosure.

FIG. 6 illustrates a chip card in accordance with aspects of the disclosure.

FIG. 7 illustrates a flowchart of a method of forming a chip card body in accordance with aspects of the disclosure.

Throughout the figures, similar reference numerals represent similar components.

### DETAILED DESCRIPTION

The present disclosure is directed to a chip card body having a first metal layer having a first aperture, and an opening or recess configured to receive a coil-chip combination, a second metal layer having a second aperture, and a booster antenna inlay laminated between the first and second metal layers and configured to couple with the coil-chip combination. The chip card body may additionally include an image formed within a transparent window as a security feature or simply a design.

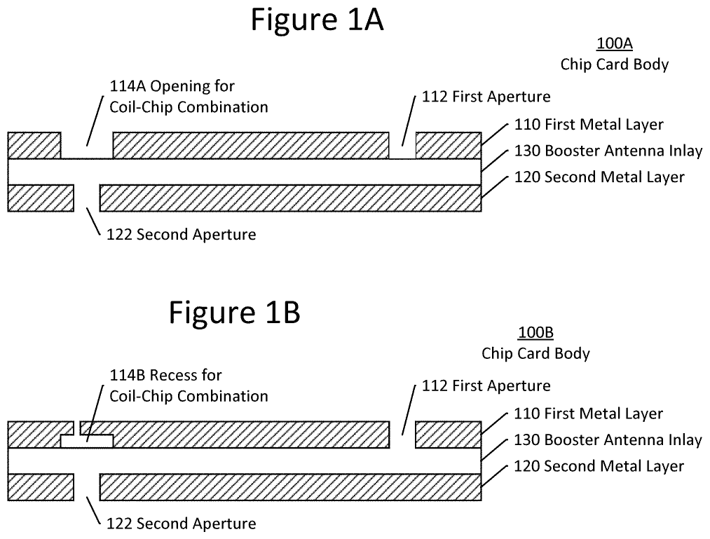

FIG. 1A illustrates a schematic diagram of a side view of a chip card body 100A in accordance with aspects of the disclosure.

The chip card body 100A comprises a first metal layer 110, a second metal layer 120, and a booster antenna inlay 130 laminated between the first and second metal layers 110, 120. The lamination may be glue or any other suitable laminating material.

The first metal layer 110 has a first aperture 112 and an opening 114A configured to receive a coil-chip combination (not shown). The coil-chip combination may be positioned after the chip card body 100A is formed.

The first aperture 112 may be in a shape of a slot, or have any other suitable shape. Also, there may be any number of first apertures 112.

The second metal layer 120 has a second aperture 122. The second aperture 122 may be in a shape of a slot, or have any other suitable shape. There may be any number of second apertures 122. The first and second metal layers 110, 120 may be formed of stainless steel, or any other suitable metal.

Each of the first and second metal layers 110, 120 has at least one aperture 112, 122, which may be filed with a material such as plastic. If the first and second metal layers 110, 120 were to not have the first and second apertures 112, 122, and instead have full metal surfaces, magnetic fields to/from the booster antenna inlay 130 would result in a formation of eddy currents. An eddy current is a loop of electrical current induced within a conductor (i.e., metal layers 110, 120) by a changing magnetic field in the conductor due to Faraday's law of induction. The first and second apertures 112, 122 function to interrupt eddy currents.

The first and second metal layers 110, 120 and their respects apertures 112, 122 may differ with respect to one another. To increase mechanical stability of the chip card body 100A, the first and second apertures 112,122 are typically not similar. For example, the first and second apertures 112, 122 may be displaced planarly with respect to one another. Also, the first and second apertures 112, 122 may be formed in different shapes and/or patterns.

The coil-chip combination may be a “Coil on Module” (CoM) which has a chip and a coil. The coil-chip combination may be dual interface so that the chip may communicate with a reader via both a contact-connected interface (i.e., an ISO pad on top) and a contactless interface (i.e., the coil).

The booster antenna inlay 130 comprises a metal antenna formed in plastic. The metal antenna may be formed with a wire in a larger loop, a smaller loop and a capacitor winding loop. The larger loop is configured to couple with a reader, and the smaller loop is configured to focus electromagnetic field energy and couple with the coil of the coil-chip combination. The capacitor winding is arranged in a way that the two ends of the one wire are wired in parallel in order to create a capacitor. Alternatively, the booster antenna inlay 130 may be formed with an etched design. Here, there are two coils (coupling coil and pick-up coil), and the capacitor has two overlapping surfaces. The coil of the coil-chip combination is arranged on top of the smaller loop and is galvanically isolated from the first and second metal layers 110, 120. The metal wire antenna may comprise copper or any other suitable metal. During operation, electromagnetic signals transmitted by a reader pass through the first and/or second apertures 112, 122 to the booster antenna inlay 130, which then couples with the coil of the coil-chip combination. A similar but reverse path is followed for electromagnetic signals transmitted by the coil-chip combination to the reader.

The chip card body 100A may have a size and thickness defined by the International Organization for Standardization (ISO), though the disclosure is not limited in this respect.

FIG. 1B illustrates a schematic diagram of a side view of a chip card body 100B in accordance with aspects of the disclosure.

The chip card body 100B is similar to the chip card body 100A of FIG. 1A, except that rather than the first metal layer 110 having an opening 114A, the first metal layer 110 has a recess 114B. In this example, the recess 114B is formed on an inner side of the first metal layer 110 so that the chip card body 100B has more of a metal surface. The coil-chip combination would then be wireless only as there is no exposed ISO pad.

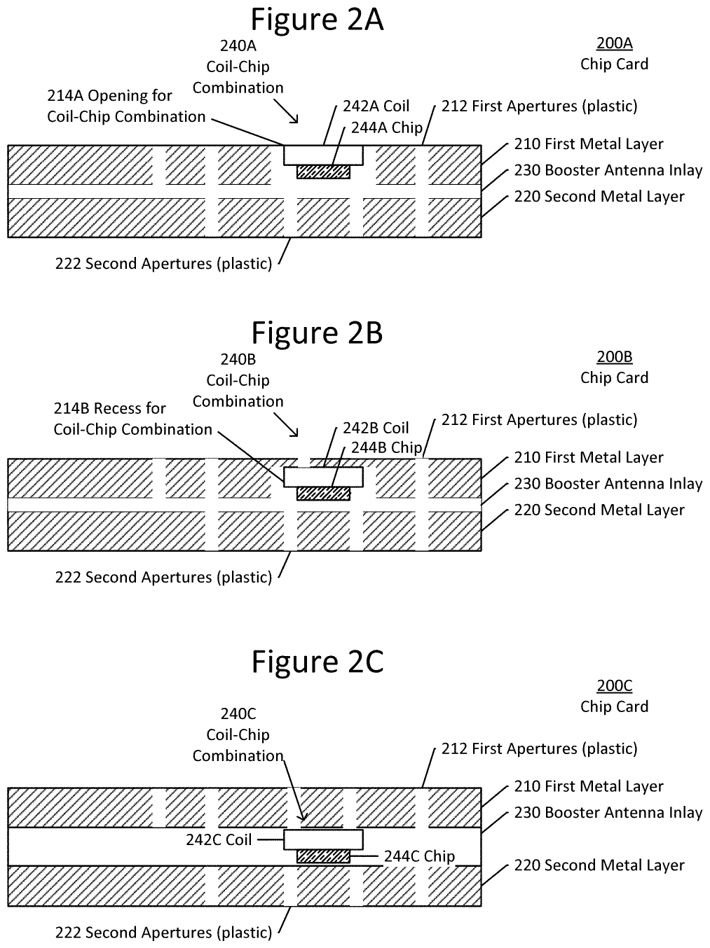

FIG. 2A illustrates a schematic diagram of a side view of a chip card 200A in accordance with aspects of the disclosure.

The chip card 200A has a chip card body 100A as disclosed in FIG. 1A, and additionally has a coil-chip combination 240A (coil 242A and chip 244A). In this example, the coil-chip combination 240A is dual-interface configured for both wireless and contact-based communications as discussed above.

FIG. 2B illustrates a schematic diagram of a side view of a chip card 200B in accordance with aspects of the disclosure.

The chip card 200B has a chip card body 100B as disclosed in FIG. 1B, and additionally has a coil-chip combination 240B (coil 242B and chip 244B), which is configured for wireless communications only.

FIG. 2C illustrates a schematic diagram of a side view of a chip card 200C in accordance with aspects of the disclosure.

The chip card 200C is similar to the chip cards 200A, 200B described above with respect to FIGS. 2A and 2B, respectively, except that the booster antenna inlay 230 comprises an opening configured to receive a wireless communications only coil-chip combination 240C (coil 242C and chip 244C). The coil 242C is formed in the same plane and is substantially concentric within an antenna portion of the booster antenna inlay 230.

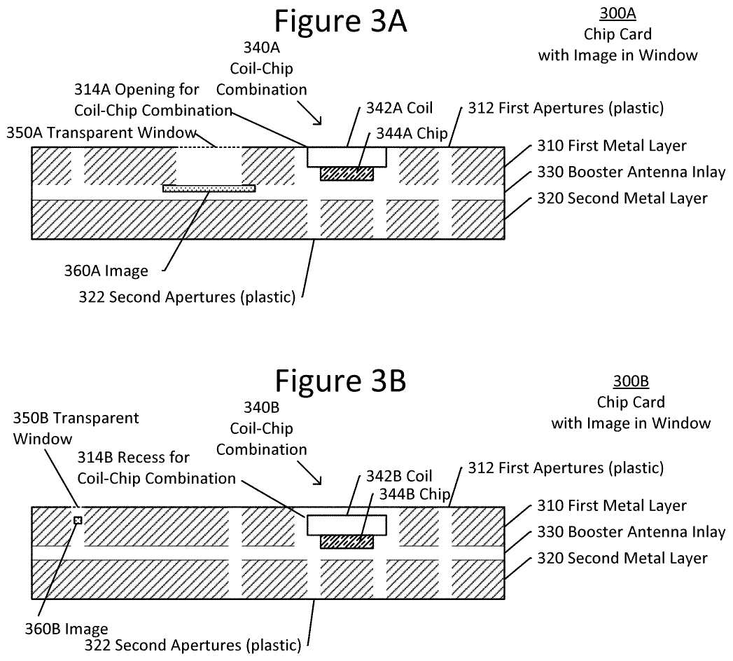

FIG. 3A illustrates a schematic diagram of a side view of a chip card 300A in accordance with aspects of the disclosure.

The chip card 300A is similar to the chip card 200A described above with respect to FIG. 2A, except that the chip card 300A additionally comprises a transparent-material window 350A and an image 360A. The window 350A may be formed within at least one of the first and second apertures 312, 322 or an additional window. The transparent-material window 350A may be made of plastic (e.g., polyimide), glass, or any other suitable material. The image 360A may be any image, such as a barcode or a hologram, and may be formed within or under the transparent-material window 350A. The image 360A may serve as a decoration, or as a security feature.

FIG. 3B illustrates a schematic diagram of a side view of a chip card 300B in accordance with aspects of the disclosure.

The chip card 300B is similar to the chip card 200B described above with respect to FIG. 2A, except that the chip card 300A additionally comprises a transparent-material window 350B in one of the first apertures 312 and an image 360B laminated into or under the window 350B.

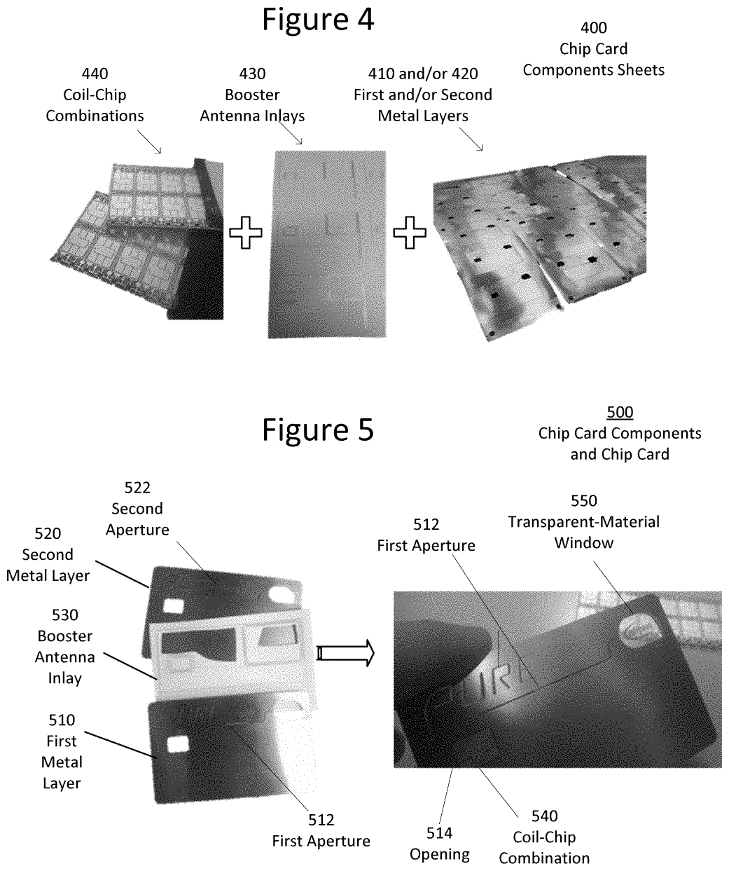

FIG. 4 illustrates chip card component sheets 400 in accordance with aspects of the disclosure.

The components sheets 400 comprise a sheet of multiple coil-chip combinations 440, a sheet of multiple booster antenna inlays 430, and a sheet of multiple first and/or second metal layers 410, 420. The components are separated from the sheets for assembly in chip card bodies.

FIG. 5 illustrates chip card components 500 in accordance with aspects of the disclosure.

The left-hand side of the figure shows a first metal layer 510, a second metal layer 520, and a booster antenna inlay 530 placed next to one another. These components are laminated together to form a chip card body as, as shown on the right-hand side of the figure. The coil-chip combination 512 may be added after the formation of the coil chip body.

The first aperture 512 is formed in over at least half of the length of the first metal layer 510, as is preferable to be most effective. In this example the first aperture 512 is a slot connected with the opening 514 configured to receive the coil-chip combination 540. The second aperture 522 is also formed in over at least half of the length of the second metal layer 520, as is preferable to be most effective.

The chip card body comprises a transparent-material window 550. This window 550 may be formed within at least one of the first and second apertures 512, 522, and thus no separate aperture for the window would be required. The transparent-material window 550 may comprise an image formed therein. In this example the image is the Infineon logo. The image may be any image, such as a barcode or hologram. The image may serve as a decoration, or as a security feature. The transparent-material window 550 may be formed in the first and second apertures 512, 522 aligned in a planar manner through the first and second metal layers 510, and 520, and an aperture in the booster antenna inlay 530 so that there is a view through the entire chip card. Also, the image may be a hologram formed within the transparent-material window 550.

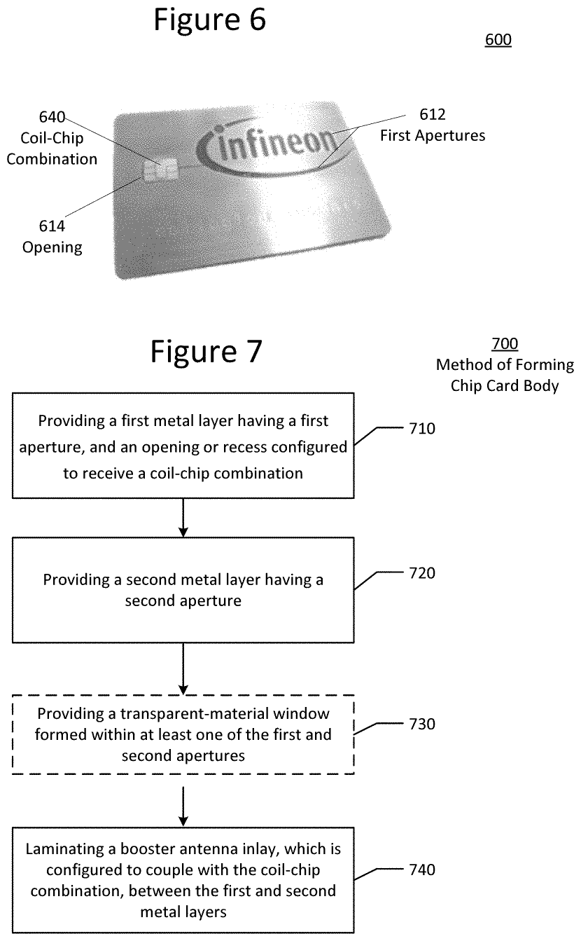

FIG. 6 illustrates a chip card 600 in accordance with aspects of the disclosure. In this example, the Infineon logo is cut into the first metal layer as the first apertures 612. The first image is the colors seen through the first apertures 612. The colors may be part of a transparent window, or alternatively, in the plastic portion of the booster antenna inlay.

FIG. 7 illustrates a flowchart 700 of a method of forming a chip card body 100 in accordance with aspects of the disclosure.

In Step 710, a first metal layer 110/210/310 having a first aperture 112/212/312, and an opening or recess 114/214/314 configured to receive a coil-chip combination 240/340 is provided.

In Step 720, a second metal layer 120/220/320 having a second aperture 122/222/322 is provided.

Optionally, in Step 730, a transparent-material window 350/550 and a hologram or other image may be provided. The transparent-material window 350/550 may be provided in the first aperture 112/212/312 and/or the second aperture 122/222/322. Alternatively, the transparent-material window 350/550 may be provided in a window opening 550 formed to be aligned in a planar manner through the first metal layer 110/210/310, the second metal layer 120/220/320, and the booster antenna inlay 130/230/330.

In Step 740, a booster antenna inlay 130/230/330, which is configured to couple with the coil-chip combination 240/340, is laminated between the first metal layer 110/210/310 and second metal layer 120/220/320.

Further, a chip card may be formed by additionally positioning a coil-chip combination 240/340 in the opening 114A/214A/314A or recess 114B/214B/314B.

While the foregoing has been described in conjunction with exemplary embodiment, it is understood that the term “exemplary” is merely meant as an example, rather than the best or optimal. Accordingly, the disclosure is intended to cover alternatives, modifications and equivalents, which may be included within the scope of the disclosure.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. This disclosure is intended to cover any adaptations or variations of the specific embodiments discussed herein.

1. A chip card body, comprising:
a first metal layer having a first aperture, and having an opening or recess configured to receive a coil-chip combination;
a second metal layer having a second aperture; and
a booster antenna inlay laminated between the first and second metal layers and configured to couple with the coil-chip combination.

2. The chip card body of claim 1, wherein at least one of the first and second apertures is a slot.

3. The chip card body of claim 2, wherein the slot is connected with the opening or recess.

4. The chip card body of claim 1, further comprising a transparent-material window formed within at least one of the first and second apertures.

5. The chip card body of claim 4, further comprising a hologram formed in the transparent-material window.

6. The chip card body of claim 4, further comprising an image formed in the transparent-material window.

7. The chip card body of claim 1, wherein the first and second apertures are displaced planarly with respect to one another.

8. The chip card body of claim 1, wherein the first and second apertures are formed in different patterns.

9. The chip card body of claim 1, wherein the first aperture is formed over at least half of the length of the first metal layer.

10. The chip card body of claim 1, wherein the second aperture is formed over at least half of the length of the second metal layer.

11. The chip card body of claim 1, further comprising a transparent-material window formed to be aligned in a planar manner through the first metal layer, the second metal layer, and the booster antenna inlay.

12. The chip card body of claim 11, further comprising a hologram formed within the transparent-material window.

13. The chip card body of claim 11, further comprising an image formed within the transparent-material window.

14. The chip card body of claim 1, wherein the booster antenna inlay comprises a metal antenna formed in plastic.

15. The chip card body of claim 1, wherein the first metal layer has the opening.

16. A chip card, comprising
the chip card body of claim 15; and
the coil-chip combination, which is a dual-interface coil-chip combination configured for both wireless and contact-based communications.

17. The chip card body of claim 1, wherein the first metal layer has the recess formed on its inner side.

18. A chip card, comprising
the chip card body of claim 17; and
the coil-chip combination, which is configured for wireless communications only.

19. A method of forming a chip card body, comprising:
providing a first metal layer having a first aperture, and having an opening or recess configured to receive a coil-chip combination;
providing a second metal layer having a second aperture; and
laminating a booster antenna inlay, which is configured to couple with the coil-chip combination, between the first and second metal layers.

20. The method of claim 19, further comprising:
providing a transparent-material window having a hologram or an image; and
positioning the transparent-material window in the first aperture or the second aperture, or a window opening formed to be aligned in a planar manner through the first metal layer, the second metal layer, and the booster antenna inlay.

21. The method of claim 19, further comprising:
providing a transparent-material window having a hologram or an image; and
positioning the transparent-material window in a window opening formed to be aligned in a planar manner through the first metal layer, the second metal layer, and the booster antenna inlay.

22. The method of forming a chip card, comprising:
performing the method of claim 19; and
positioning the coil-chip combination in the opening or recess.

23. A chip card body, comprising:
a first metal layer having a first aperture;
a second metal layer having a second aperture; and
a booster antenna inlay laminated between the first and second metal layers, and comprising an opening configured to receive a wireless communications only coil-chip combination, wherein the booster antenna inlay is configured to couple with the coil of the coil-chip combination.

24. The chip card body of claim 23, wherein the coil is formed in the same plane and substantially concentric within an antenna portion of the booster antenna inlay.
